(19) United States
(12) Patent Application Publication
(10) Pub. No.: US 2013/0073636 A1
(43) Pub. Date: Mar. 21, 2013

(54) GROUP CHAT ACROSS NETWORKS

(71) Applicants: Zhongwen Zhu, Saint-Laurent (CA); Sylvie Lachize, Montreal (CA); Francis Page, Laval (CA); Martin Cayouette, Montreal (CA)

(72) Inventors: Zhongwen Zhu, Saint-Laurent (CA); Sylvie Lachize, Montreal (CA); Francis Page, Laval (CA); Martin Cayouette, Montreal (CA)

(73) Assignee: TELEFONAKTIEBOLAGET L M ERICSSON (PUBL), Stockholm (SE)

(21) Appl. No.: 13/334,305

(22) Filed: Dec. 22, 2011

Related U.S. Application Data
(60) Provisional application No. 61/536,356, filed on Sep. 19, 2011.

(51) Int. Cl. G06F 15/16

(52) U.S. Cl. 709/206

(57) ABSTRACT

A system and method for enabling a multi platform chat service defines communication channels in accordance with group member presence information and allows the delivery of messages to the group members through the channels. When a recipient of a message replies, the reply is distributed in the same manner as the original message.

### CROSS REFERENCE TO RELATED APPLICATIONS

This application claims the benefit of priority to U.S. Provisional Patent Application No. 61/536,356, filed Sep. 19, 2011, the contents of which are expressly incorporated herein by reference.

### TECHNICAL FIELD

This disclosure relates generally to mechanisms for enabling multi-user chat sessions. In particular, this disclosure related to systems and methods for enabling a multi-user chat across a plurality of social networks.

### BACKGROUND

Instant messaging clients are well known in the field of online communications. They typically involve a server that allows two nodes to connect to each other for the purposes of a chat session. The data exchanged between the nodes is often relayed through the server, as shown in FIG. 1. Those skilled in the art will appreciate that in some embodiments the two user nodes can communicate directly with each other after being connected by the server. As illustrated in FIG. 1, a chat server 100 provides a service utilized by user 1 at node 102 and user 2 at node 104. Each of the user nodes 102 and 104 performs a login communication, 106a and 106b respectively, with the chat server 100. By logging into chat server 100, each user is able to obtain a list of users that are registered as online with chat server 100. User 1 node 102, upon obtaining an indication that user 2 is online, is able to send a message 108a to chat server 100 that is addressed to user 2. Chat server 100 can then forward the received message to user 2 at node 104 in message 108b. A reply 110 to message 108 (composed of messages 108a and 108b) can be sent as message 110a to the chat server 100 and message 110b from the chat server 100 to node 102 for review by user 1. As noted above, in some embodiments, it is possible for chat server 100 to extricate itself from the communications path, allowing messages 108 and 110 to be sent directly between node 102 and node 104.

As different chat services arose, there grew a demand for the chat services to interoperate with each other. Such a setup is illustrated in FIG. 2. User 1 at node 102 connects to chat server 1 112, while user 2 at node 104 connects to chat server 2 114. After users nodes 102 and 104 perform login processes 116 and 118, user 1 node 102 can issue message 120 to chat server 1 112, which then forwards the request as message 122 to chat server 2. Chat server 2 can acknowledge receipt of the message using ok message 124, and then forward the message to user 2 104 as message 126. Other mechanisms for allowing communication between individuals on chat services and other social networks will be known to those skilled in the art. Reply messages would take the same form as the initial message as will be well understood by those skilled in the art.

One consequence of users making use of a plurality of different communication services (e.g. email and instant messaging) and social networks, is that the social graph of a user is fragmented. On each service, a portion of the user's social network is represented. Although there is some overlap, there are also unique elements on each system. This problem has been partially addressed for some mobile devices that permit a user to enter a series of credentials, each credential providing access to the social graph of each service that the user has subscribed to. The mobile device can then assemble a more complete picture of the social interactions based on the overlapping data sets held by each service or social network. FIG. 3 illustrates one such solution. A mobile device 150 receives credential1 152, credential2 154 and credential3 156 from the user. Each of these credentials is associated with a different service or social networks. The mobile device issues a request 158 to service 1 160 asking for social graph information associated with the user. This request 158 includes credential1 152 as proof of user authorization for the request. Service 1 160 provides response 162. Similarly, request 164 is provided to service 2 166 and results in response 168, while request 170 is provided to service 3 172 resulting in response 176. These responses are stored in memory 178 where they are processed to determine overlap and define the social graph of the user.

Unfortunately, although a user may be provided with a complete social graph as a result of such a system, it is often difficult to communicate with a plurality of different users on a plurality of different systems in a single conversation. Although there has been some progress to allowing internetwork or interservice chat, this is not always permitted. Even when it is permitted, it is typically restricted to a user-to-user interaction, and does not provide the user with the ability to create a group chat session across a plurality of different services.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of supporting a group chat on a data based network between a plurality of participants initiated by a first participant. The method comprising the steps of: determining presence information, defining messaging distribution channels and forwarding a message. In the step of determining, presence information is determined for each of the plurality of participants across a plurality of messaging platforms. Each of the plurality of messaging platforms is accessible through a data network. In the step of defining, a plurality of message distribution channels is defined in accordance with the determined presence information. In the step of forwarding, a message is forwarded to each of the plurality of participants through the defined plurality of message distribution channels over the data network.

In an embodiment of the first aspect, the step of determining includes identifying a plurality of messaging platforms associated with a participant in the plurality, and requesting presence information associated with the participant from each of the identified plurality of messaging platforms. In a further embodiment, the step of defining includes selecting, for one of the plurality of participants, a messaging platform through which messages can be delivered in accordance with determined presence information associated with the one participant. In another embodiment, one of the plurality of messaging platforms is an instant message based messaging platform. Alternatively, one of the plurality of messaging platforms is a social network platform. In a further embodiment, the step of defining includes selecting a Short Message Service (SMS) based delivery channel for a participant in the plurality in response to determining that the participant is not present on any of the plurality of messaging platforms. In another embodiment, the message is a status message indicating the distribution channel associated with a participant in the plurality. In another embodiment, the message is a message received from a participant in the plurality and the step of forwarding includes modifying the received message to indicate the participant from whom the message was received prior to forwarding the message.

In a further embodiment of the first aspect, the step of forwarding includes transmitting, on behalf of the first participant, a message to a messaging platform addressed to a participant in the plurality. Optionally, the transmitted message is addressed to more than one participant in the plurality. In another embodiment, the step of determining is performed in response to receiving a request to initiate the chat specifying the participants from the first participant.

In a further embodiment, the step of determining is performed in response to receiving a message for distribution to the group chat participants. Optionally, the message for distribution is received from a participant in the plurality other than the first participant. In such a case, the step of determining may include redetermining the presence information associated with each participant in the plurality. Optionally, the step of defining includes redefining the plurality of distribution channels in accordance with newly determined presence information.

In a second aspect of the present invention, there is provided a system for enabling a chat session between a plurality of participants initiated by a first participant. The system comprises a user interface, a messaging interface, a contact database and a messaging processor. The user interface receives a request to initiate a chat session from the first participant and both sends messages to and receives messages from the first participant over a data network. The messaging interface sends messages to and receives messages from a plurality of external messaging platforms over a data network. The contact database stores contact information associated with each of the plurality of participants, and stores credentials associated with each of the plurality of the external messaging platforms and the first participant. The messaging processor determines presence information associated with each of the plurality of participants in accordance with contact information associated with each of the plurality of participants in the contact database and information obtained from the plurality of external messaging platforms through the messaging interface, defines a delivery channel for each participant in the plurality in accordance with the determined presence information responsive to receipt of a message from a participant over one of the user interface and message interface, and forwards the received message to the plurality of participants over the defined delivery channels.

In an embodiment of the second aspect, the messaging interface is comprised of a plurality of messaging interfaces, each of the plurality for sending messages to and receiving messages from a single external messaging platform. In another embodiment, the external messaging platforms are instant messaging based platforms and social network based platforms. In a further embodiment, the messaging interface includes a data network interface to communicate with the external messaging platforms over the data network. In another embodiment, the contact database is externally hosted and is connected to the messaging processor through a database interface and a data network.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram illustrating a chat server system;

FIG. 2 is a block diagram illustrating a multi-server chat system;

FIG. 3 is a block diagram illustrating a mobile device for building a social graph on behalf of a user;

FIG. 4 is a block diagram illustrating the use of a network agent/network address book for connecting a user to a plurality of communication services;

FIG. 5 is a message flow diagram illustrating the initialization and commencement of a group chat session;

FIG. 6 is a message flow diagram illustrating an alternate embodiment for the distribution of messages in a group chat session

FIG. 7 is a flowchart illustrating a method of enabling a group chat across platforms;

FIG. 8 is a flowchart illustrating an embodiment of the method shown in FIG. 7;

FIG. 9 is flowchart illustrating an embodiment of the method shown in FIG. 7;

FIG. 10 is a flowchart illustrating an embodiment of the method shown in FIG. 7;

FIG. 11 is a flowchart illustrating an embodiment of the method shown in FIG. 7; and

FIG. 12 is a block diagram illustrating an exemplary embodiment of a system for carrying out the methods of FIGS. 7-11

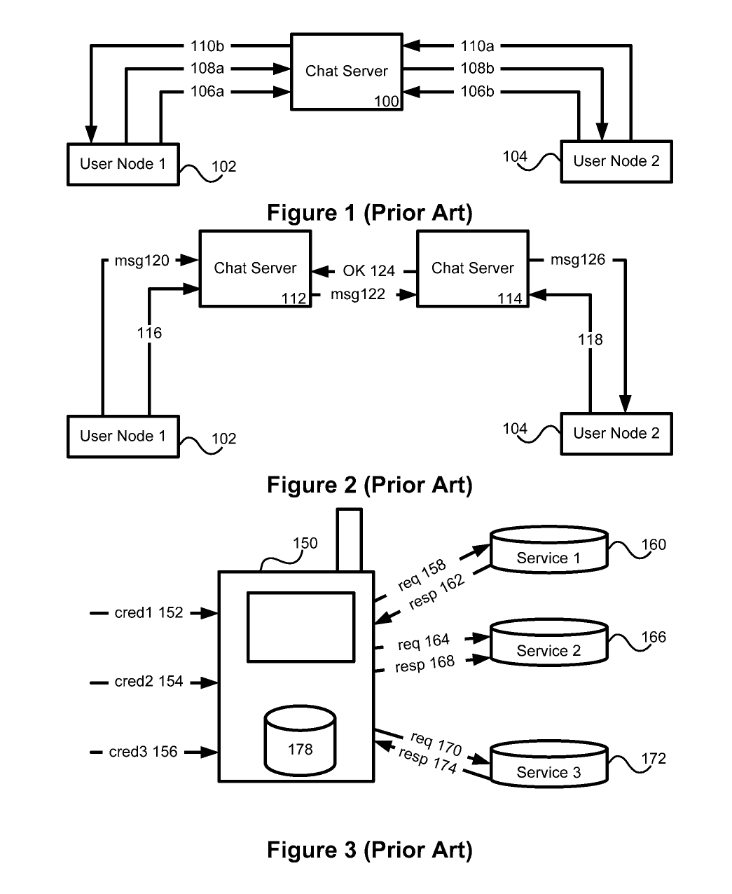

### DETAILED DESCRIPTION

The present invention is directed to a system and method for enabling a group chat across a plurality of platforms.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

Presented herein is a method and system that makes use of a resource such as a network address book to act as a user agent in each of the services and social networks that the user is a part of This resource can be network based, or it can be resident on a piece of end user equipment. For the purposes of improving availability and for simplifying the discussion below, a network implemented resource will be discussed, although those skilled in the art will appreciate that this is not intended to be limiting in scope. A network based address book can use user credentials with a social networking service to obtain the fragment of the user's social graph associated with the social networking service. As the network address book connects to each of the social networking services, or messaging platforms, that the user is registered with, a complete social graph can be created. Each contact that the user is connected with can be represented on a plurality of different social networking services. The network address book service can consolidate the contact information of each of the user's connections. With a cross-platform picture of the user's connections, the network address book

A user's network address book can be built on the basis of the social networks and other services that he is registered with, and supplemented with other information such as email addresses and telephone numbers. Thus, if a user is connected to a contact on a first social network, it is understood that the network address book can act as the user's agent on that first social network to connect and communicate with that contact. The address book can be built from a plurality of sources including the native address book from mobile devices, the address book from email clients, and different social networks where the user has registered before, e.g. Facebook, Twitter, Voice Over IP providers such as Skype, and network or web based email clients such as Google's Gmail, Yahoo! Mail, mail provided through the Microsoft Network, and other mail platforms such as corporate email platforms, as well as instant messaging platforms such as Google Talk, Yahoo! Instant Messenger, MSN Messenger, as well as corporate messaging platforms.

In order to allow NAB (network Address Book) to import these contacts, the user typically provides the corresponding credential in each social network and authorizes the NAB to fetch the contact information from those social networks. This is the first time that the user authorizes the NAB to act as his agent. At this time, NAB has the permission to access the social network on behalf of the user. With the access authorized by end user and social network, NAB is able to utilize the services in the social network that the user is entitled to have. One of the services in many social network platforms is “one-to-one chat”. Here the requirement for NAB to use the chat service is to the ability to interact with the chat service on behalf of the user, preferably through an Application Program Interface (API). If the user has a plurality of social network accounts, the interfaces to the corresponding chat clients are activated in NAB. When this has been achieved, the NAB is able, on the behalf of the user, to chat with user's connections on different networks. Similarly, in some networks (both social networking platforms and instant messaging networks) multi-party chat sessions can be created. The NAB can act as the user agent in a multiparty chat using the same mechanisms discussed above for the one-on-one chat services.

Based upon this interaction with a plurality of different messaging platforms, a group chat service can be enabled. The NAB allows the user to select contacts to engage in a chat session. These contacts do not need to have access to a common messaging platform. Instead, the NAB can select a messaging platform to reach each user on. A series of single party or multiparty chat sessions can then be created by the NAB. A message sent from the user through the NAB-based agent is relayed into each of the relevant messaging platforms. Any reply is received by the NAB and can be forwarded to the platforms of the other users. Thus, the NAB based messaging agent is able to act as an intermediary to facilitate communication not just between the user and the disparate messaging platforms, but also as as intermediary between the disparate platforms. It should be noted that every time a message is received by the NAB it could determine which contacts are available on which platforms to provide the best chance at delivering the message. If a chat session participant has left a social network, but either email or a phone number is available, the NAB could use either email or an SMS-based messaging delivery system to continue the chat session.

Because messages to participants will always be sent from the account of the user associated with the NAB, the NAB can modify all received messages to provide an indication of who sent the message. The NAB can also provide status information to the chat session participants about the other participants as messages. Thus if a user switches from one messaging platform to another, the NAB could send a message to the other participants informing them of the switch. This can be used to provide rudimentary presence information, and will pre-emptively explain to chat session participants why a particular user is no longer as responsive.

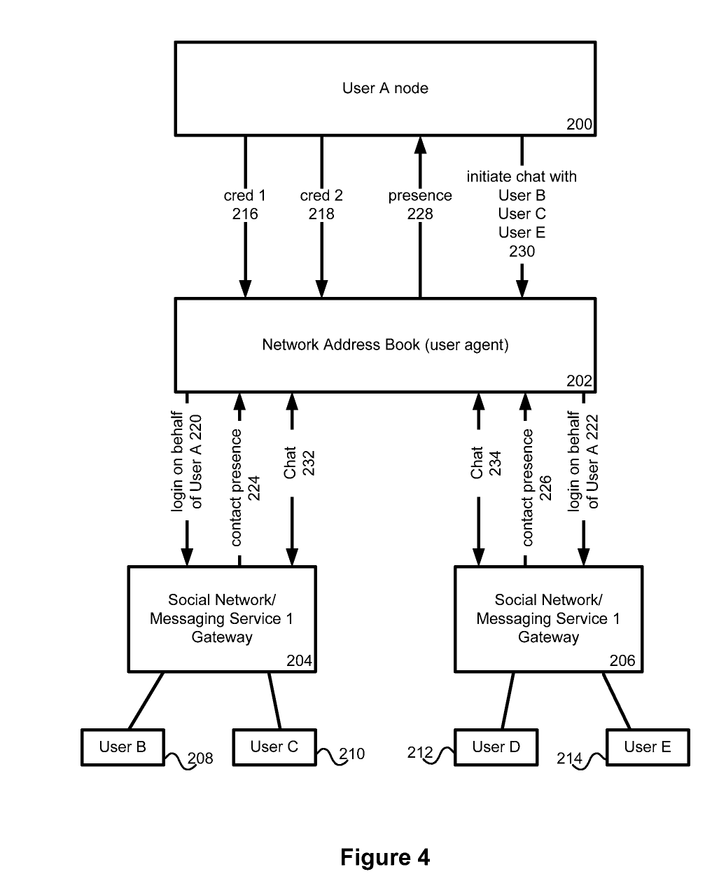

FIG. 4 illustrates a logical embodiment of a system as described above. User A device 200 is used to interact with Network Address Book/Agent 202, which has connections to Social Network 1 through its gateway 204 (preferably through an API), and social network 2 through its gateway 206. User A is connected to users B and C, using devices 208 and 210, through social network 1, and is connected to users D and E, using devices 212 and 214, through social network 2. It should be noted that there is no need for any of users B C D and E to be connected to each other on any social networking/messaging platforms.

User A device 200 provides authentication credentials for social network 1 to NAB 202 in communication 216, and provides the corresponding credentials for social network 2 in communication 218. Logins to the corresponding social networks are performed on behalf of user A in communications 220 and 222. In response to logging in, the social network/messaging platform gateways 204 provide contact presence information 224 and 226 to the NAB 202. NAB 202 consolidates the presence information and provides it to user A device 200 in message 228. User A device 200 instructs NAB 202 to initiate a chat session across networks with users B C and E in message 230. NAB 202 then issues chat requests 232 and 234.

As noted, communication channels 232 and 234 are bidirectional, allowing participants in the chat session to respond to messages sent by the initiator. The NAB 202, upon receipt of any message, determines the users that the message should be delivered to, identifies the messaging platform that the message should be sent over to allow for the delivery, and then sends the message (which may have been modified for such reasons as identification of the sender) to the relevant recipients.

One way of understanding the operation of the above described service is to define a logical group chat object (referred to as the GCHAT object). All the messages sent by the group members arrive at this GCHAT object. Then the message is redistributed to the remaining group members to whom the message has not been delivered. The group owner can act as a bridge to connect all the group members across different social networks and messaging platforms as well as telecom network.

To allow for communication with a user that is not present in social networks and other platforms, his/her MSISDN can used to send the message using SMS. In such a case, the NAB would send an SMS message on behalf of the user who initiated the session. Similarly, such a user could be reached by email if such contact information is available.

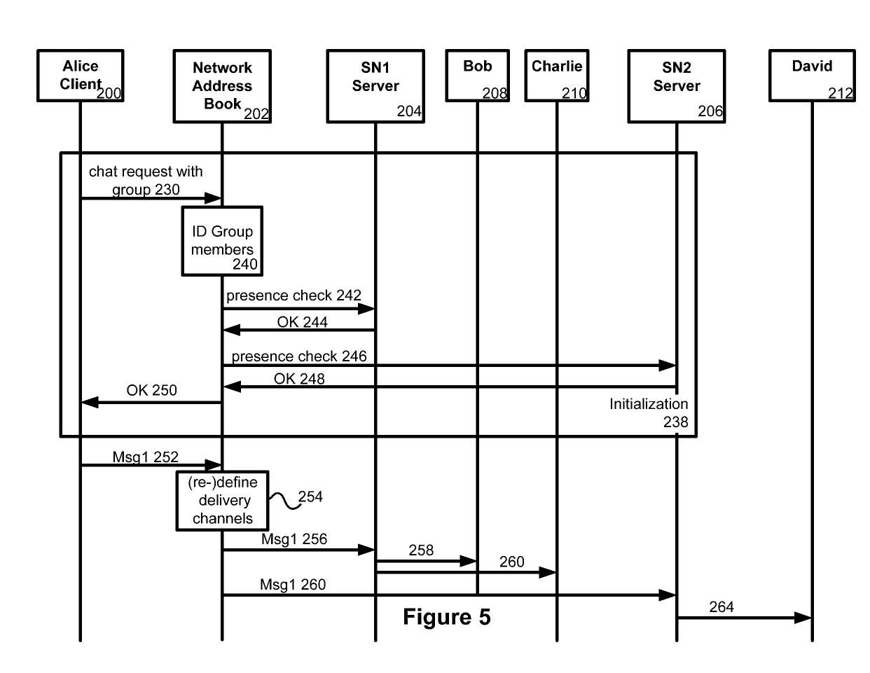

FIG. 5 outlines a messaging flow for an exemplary chat session as illustrated in FIG. 4. An initialization process 238 is described in detail. A user, Alice, makes use of her client 200 to send a message 230 to the NAB 202 to initialize a session. In response, the NAB 202 identifies a number of contacts as being associated with a group chat 240. As part of this process, based on the address book information for each of the identified users, the NAB determines how Alice is connected to each of the contacts. A presence request is send to the appropriate social network servers (presence check message 242 and 246 sent to messaging platform 1 server 204 and messaging platform 2 server 206 respectively), and responses 244 and 248 are gathered. Based on these responses, delivery channels can be defined.

When Alice issues a message 252 for delivery, it is received by the NAB 202. NAB 202 can optionally redetermine the delivery channels in step 254 if sufficient time has elapsed from the obtaining of the presence information. NAB 202 then forwards a command containing message 252 to the social network servers while acting as an agent for Alice. Message1 256 is delivered to SN1 server 204 which then delivers the message to recipients Bob 208 and Charlie 210 in messages 258 and 260. Message1 262 is delivered to SN2 server 206 which then delivers the message to recipient David 212 in message 264. In the illustrated embodiment, the social networking server is then relied upon to explode the message to the relevant users.

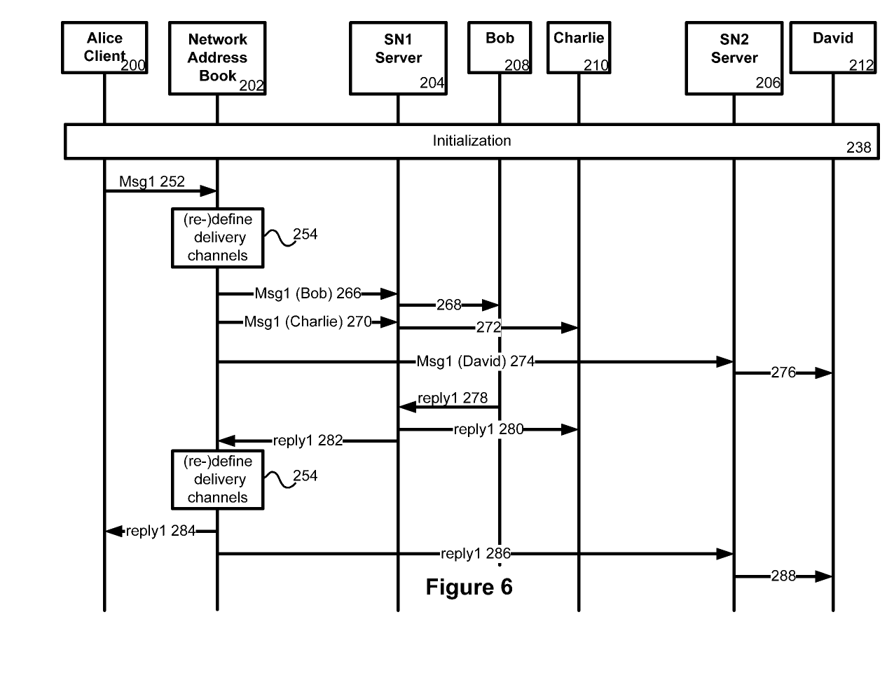

In another embodiment, NAB 202 can issue multiple instructions to SN1 server 204 to ensure delivery of the messages to Bob 208 and Charlie 210. This alternate embodiment is illustrated in FIG. 6. Following initialization 238, the message is sent to each user individually by the NAB. A hybrid of these systems can be used depending on the manner in which each social networking server is configured. As illustrated, message1 252 is received by NAB 202 and the copy intended for delivery to Bob 208 is delivered to SN1 gateway 204 as message 266. SN1 gateway then forwards the message on as message 268. The copy intended for Charlie 210 is delivered to SN1 gateway 204 as message 270 and is forwarded to Charlie 210 as message 272. The copy intended for David 212 is forwarded to SN2 gateway 206 as message 274 and is forwarded as message 276.

If chat participant Bob 208 wishes to reply, message reply1 278 is sent to SN1 gateway 204. SN1 gateway 204 can optionally determine that Charlie 210 is a part of a multiparty chat and deliver reply1 in message 280. Reply1 is also sent to NAB 202 in message 282. Upon receipt of message 282, NAB 202 optionally determines the participants that the message should be forwarded to and the appropriate delivery channels in step 254, and forwards reply1 to Alice 200 in message 284 and to David 212 through SN2 gateway 206 as message 286 which is forwarded as message 288.

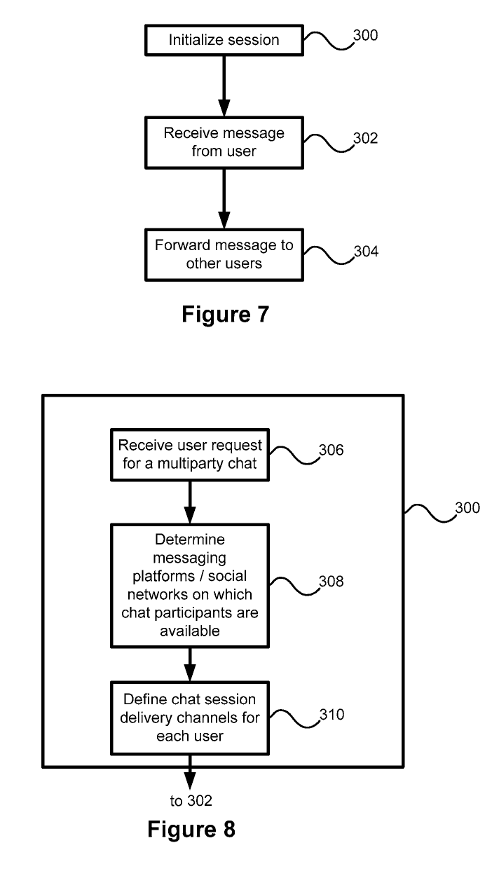

Exemplary methods of the present invention are illustrated in the flow charts of FIGS. 7-11. Those skilled in the art will appreciate that the following discussion is intended to be exemplary in nature and should not be considered as restrictive of the scope of the present invention, which is solely defined in the attached claims.

FIG. 7 illustrates an exemplary method used in the above examples at the NAB 202. In step 300 the chat session is initialized. This is typically done in response to receipt of an initialization request identifying the intended recipients. In step 302 a message is received from the originating user and in step 304, the message is forwarded to other users. Those skilled in the art will appreciate that the message can be modified before forwarding to indicate that this is a message delivered in a group chat session. The message can also be modified to indicate who sent the message. In forwarding the message to the chat session participants, the delivery channels identified in the session initialization are preferably used.

FIG. 8 illustrates an exemplary embodiment of step 300 of FIG. 7. The NAB receives a request from the user for a group chat session in step 306. In step 306, the participants associated with the chat session are identified, and based on the socials graph of the user, the delivery channels through which these connections can be reached are determined. In step 310, a delivery channel for each user is defined.

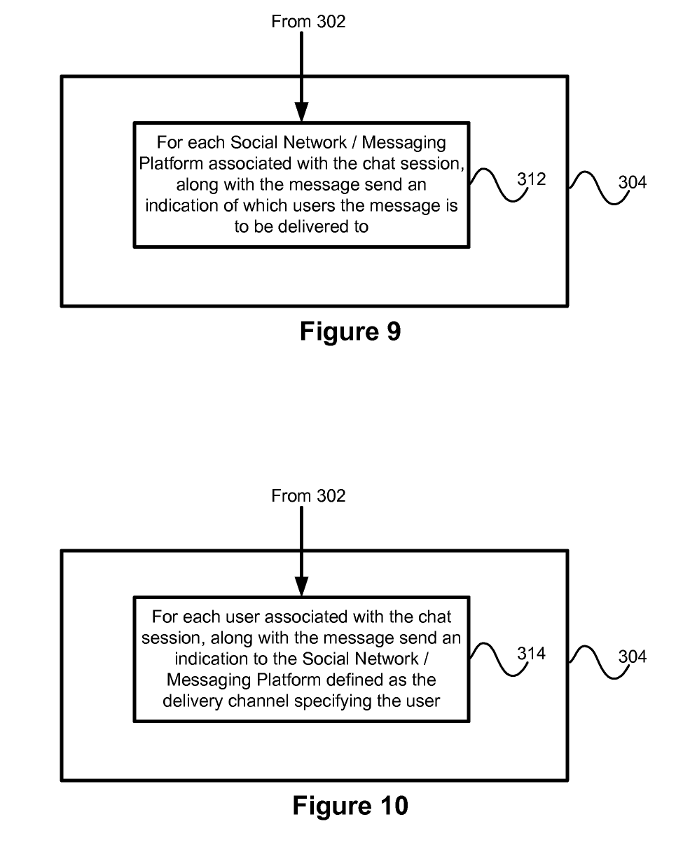

One skilled in the art will appreciate that FIG. 9 illustrates an exemplary embodiment of the method of FIG. 7, where step 304 of forwarding the message includes step 314 of sending each social network/messaging platform a message including a list of users that the message should be distributed to.

FIG. 10 illustrates an alternate embodiment to the method shown in FIG. 9. In the method illustrated by FIG. 10, in step 304 each participant in the chat session is sent an individual message in step 314.

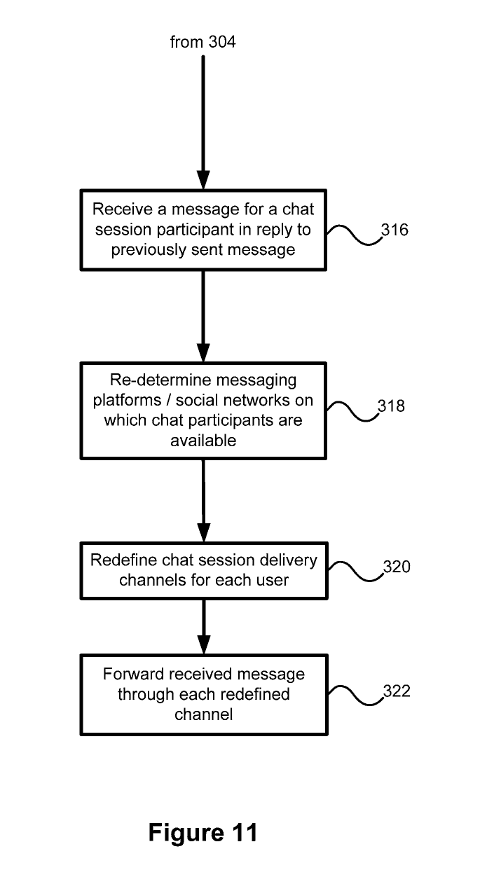

FIG. 11 illustrates the handling of a message received in response to step 304 of FIG. 7. In step 316 a message is received in reply to a previously delivered message. This reply originates with one of the chat participants (possibly even the originating user). In step 318 a process of determining which chat session users are online similar to that of step 308 is undertaken, and in step 320 a process of defining delivery channels similar to that of step 310 is undertaken. In step 322 the reply message received in step 316 is forwarded through the channels defined in step 320.

By redefining channels before each transmission, a connection may become inactive on one platform but be available on another. The redefining of the channels allows that user to still be a seamless part of the conversation.

One skilled in the art will appreciate that if a message sent by NAB 202 is undeliverable by one of the messaging platform gateways, a delivery failure message can be provided to NAB 202. This can be treated as a trigger to initiate a redefinition of the delivery channel to any or all of the chat session participants.

As noted above, if a user is no longer available on a messaging platform, but has become available on another platform the redefinition of delivery channels can allow for the user to be reached where available. If the participant has logged off all messaging platforms through which he is connected to the originating user, the NAB can deliver messages to the participant using SMS messaging. The NAB can send the messages either through an MSISDN associated with the chat session in general but not uniquely associated with any of the participants in the chat session, or through an MSISDN associated solely with the originating user. As noted above, any message delivered can be modified to indicate the participant who created message, and optionally to indicate that the message is a part of a chat session.

An interface to the NAB can be provided to the originating user on a number of different platforms. An HTML based interface can be used to provide the group owner (e.g. Alice) to access the NAB and log in securely using authentication credentials. The NAB can then retrieve profile information from a number of standard storage solutions.

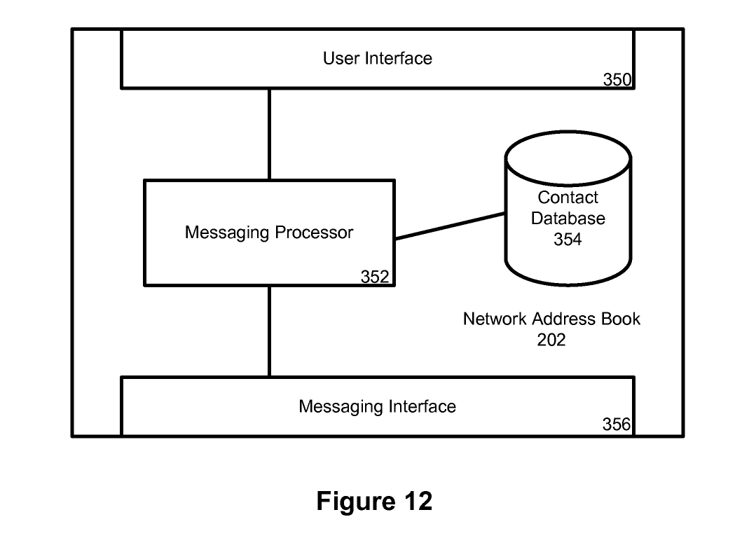

FIG. 12 illustrates a block diagram of an exemplary system of the present invention. NAB 202 includes a user interface 350 through which it is able to communicate to the user. The messaging processor 352 receives the user request for a chat session over user interface 350. The list of participants is extracted from contact database 354, and from the extracted information, processor 352 interrogates a selection of messaging platforms and social network platforms through messaging interface 356. The first interrogation is typically determining which of the social network platforms and messaging platforms associated with each user are available channels. When a set of available channels for each user is determined, the processor selects a channel for each participant. The selection of a channel for a user when there are a plurality of channels available can be done using a number of different methods including a ranked list that prioritizes the minimization of messaging platforms used, a ranked list that prioritizes the preferences of the user, a ranked list that prioritizes the preference of each participant, a combination of the above or other such mechanisms that would be well understood by those skilled in the art. Upon selecting a channel for each user, the set of selected channels can then be used by the processor 352 to send a message received from the user over user interface 350 to each of the messaging platforms and social network platforms over messaging interface 352. When a message from a participant is received by processor 352 over interface 356, the distribution channels can be redetermined so that a participant that has logged out of the platform or network that was defined will still be reached. One skilled in the art will appreciate that messaging interface 356 can be either a single interface or a plurality of different interfaces, one for each of the platforms and networks that are used. As noted above, if a participant has a mobile phone number stored in the contact database 354 and is not active or online with any platform or network, messages can be relayed to the participant using SMS messages.

As noted above, processor 352 can modify a message received from any of the participants in a session so that the body of the message contains an identification of which user sent the message. As the interaction with each messaging platform or social network utilizes the first user's identity, messages received by the participants may initially appear to be from the first user even when they originated from another participant. Additionally, processor 352, upon determining that a participant has changed networks or has been switched over to SMS based delivery can send a status update message to the remaining participants to provide a form of presence information.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of supporting a group chat on a data based network between a plurality of participants initiated by a first participant, the method comprising the steps of:
determining presence information for each of the plurality of participants across a plurality of messaging platforms, each of the plurality of messaging platforms accessible through a data network;
defining a plurality of message distribution channels in accordance with the determined presence information; and
forwarding a message to each of the plurality of participants through the defined plurality of message distribution channels over the data network.

2. The method of claim 1 wherein the step of determining includes identifying a plurality of messaging platforms associated with a participant in the plurality, and requesting presence information associated with the participant from each of the identified plurality of messaging platforms.

3. The method of claim 1 wherein the step of defining includes selecting, for one of the plurality of participants, a messaging platform through which messages can be delivered in accordance with determined presence information associated with the one participant.

4. The method of claim 1 wherein one of the plurality of messaging platforms is an instant message based messaging platform.

5. The method of claim 1 wherein one of the plurality of messaging platforms is a social network platform.

6. The method of claim 1 wherein the step of defining includes selecting a Short Message Service (SMS) based delivery channel for a participant in the plurality in response to determining that the participant is not present on any of the plurality of messaging platforms.

7. The method of claim 1 wherein the message is a status message indicating the distribution channel associated with a participant in the plurality.

8. The method of claim 1 wherein the message is a message received from a participant in the plurality and the step of forwarding includes modifying the received message to indicate the participant from whom the message was received prior to forwarding the message.

9. The method of claim 1 wherein the step of forwarding includes transmitting, on behalf of the first participant, a message to a messaging platform addressed to a participant in the plurality.

10. The method of claim 9 wherein the transmitted message is addressed to more than one participant in the plurality.

11. The method of claim 1 wherein the step of determining is performed in response to receiving a request to initiate the chat specifying the participants from the first participant.

12. The method of claim 1 wherein the step of determining is performed in response to receiving a message for distribution to the group chat participants.

13. The method of claim 12 wherein the message for distribution is received from a participant in the plurality other than the first participant.

14. The method of claim 13 wherein the step of determining includes redetermining the presence information associated with each participant in the plurality.

15. The method of claim 13 wherein the step of defining includes redefining the plurality of distribution channels in accordance with newly determined presence information.

16. A system for enabling a chat session between a plurality of participants initiated by a first participant, the system comprising:
a user interface for receiving a request to initiate a chat session from the first participant and for sending messages to and receiving messages from the first participant over a data network;
a messaging interface for sending messages to and receiving messages from a plurality of external messaging platforms over a data network;
a contact database for storing contact information associated with each of the plurality of participants, and for storing credentials associated with each of the plurality of the external messaging platforms and the first participant; and
a messaging processor for determining presence information associated with each of the plurality of participants in accordance with contact information associated with each of the plurality of participants in the contact database and information obtained from the plurality of external messaging platforms through the messaging interface, for defining a delivery channel for each participant in the plurality in accordance with the determined presence information responsive to receipt of a message from a participant over one of the user interface and message interface, and for forwarding the received message to the plurality of participants over the defined delivery channels.

17. The system of claim 16 wherein the messaging interface is comprised of a plurality of messaging interfaces, each of the plurality for sending messages to and receiving messages from a single external messaging platform.

18. The system of claim 16 wherein the external messaging platforms are instant messaging based platforms and social network based platforms.

19. The system of claim 16 wherein the messaging interface includes a data network interface to communicate with the external messaging platforms over the data network.

20. The system of claim 16 wherein the contact database is externally hosted and is connected to the messaging processor through a database interface and a data network.
